(19) United States
(12) Patent Application Publication
(10) Pub. No.: US 2025/0368918 A1
(43) Pub. Date: Dec. 4, 2025

(54) PERFUME CONCRETE AND ABSOLUTE WHICH ARE OBTAINED BY ALKANE SOLVENT EXTRACTION FROM SOLID NATURAL SUBSTANCES

(71) Applicant: L'OREAL, Paris (FR)

(72) Inventors: Géraldine DU ROIZEL, Aulnay-Sous-Bois (FR); Hervé DAVID, Aulnay-Sous-Bois (FR)

(73) Assignee: L'OREAL, Paris (FR)

(21) Appl. No.: 18/836,501

(22) PCT Filed: Apr. 19, 2023
(86) PCT No.: PCT/EP2023/060186

§ 371 Date: Aug. 7, 2024

(30) Foreign Application Priority Data
Apr. 20, 2022 (FR) FR2203644

(51) Int. Cl. C11B 9/02

(52) U.S. Cl. CPC C11B 9/025

(57) ABSTRACT

The present invention relates to a process for preparing perfume concrete and/or absolute which employs bringing particular, fresh, withered or dry, solid natural material(s) into contact with a first system of solvents comprising at least one “green” alkane solvent comprising at least 8 carbon atoms. Another subject of the invention is the perfume concrete and the perfume absolute obtained by the preparation process, a composition comprising the concrete and/or the absolute, and the use of the “green” alkane solvent to extract the concrete and/or the absolute with no chemical odour of solvent odour type.

The present invention relates to a process for preparing perfume concrete and/or absolute which employs bringing particular, fresh, withered or dry, solid natural material(s) into contact with a first system of solvents comprising at least one, preferably “green”, alkane solvent having at least 8 carbon atoms. Another subject of the invention is the perfume concrete and the perfume absolute obtained by the preparation process, a composition comprising the concrete and/or the absolute, and the use of at least one, preferably “green”, alkane solvent having at least 8 carbon atoms to extract the concrete and/or the absolute with no chemical odour of solvent odour type, with persistence, intense and powerful odor, notes, and/or very close to the starting natural material (biomass).

The cosmetics industry and in particular the perfumery industry includes numerous processes for the extraction of odorous molecules, such as enfleurage, hydrodistillation, expression, atomization, supercritical CO₂ extraction, and the like. Among these, extraction by non-polar volatile solvents, such as n-hexane, represents, for certain natural raw materials, a good technique for the extraction of odorous molecules, in particular owing to a good solubilizing power, a lower boiling point than water and easy vacuum distillation. This technique is favoured for the large-scale production of absolutes, used as raw materials in perfumery, in particular in the case where hydrodistillation could not be applied due to the high boiling point of water, which could detrimentally affect the natural raw materials, notably plant materials. By this process, natural materials, in particular plant materials, are subjected to several successive washing operations with a first volatile organic solvent 1. Separation by settling and then the evaporation under vacuum of the solvent 1 make it possible to obtain the “concrete”. An optional treatment of the “concrete” with a second solvent 2, in particular ethanol, makes it possible to remove the impurities present (waxes, and the like) and thus to obtain the “absolute” after evaporation of the solvent 2 (see Kirk-Othmer Encyclopedia of Chemical Technology, “Perfumes”, John Wiley & Sons Inc., K. D. Perring, pp. 1 to 46 (2016) DOI: 10.1002/0471238961.1605180619030818.a01.pub3, and Ullmann's Encyclopedia of Industrial Chemistry, “Perfumes”, M. V. Ende, W. Sturm and K. Peters, Wiley-VCH Verlag Gmbh & Co. KGaA, Weinheim, (2017) https://onlinelibrary.wiley.com/doi/epdf/10.1002/14356007.a19_171.pub2). Among these various extraction techniques, extraction by volatile solvents is the favoured method for obtaining “concretes” and then “absolutes” of certain natural materials, such as perfumery raw materials. To do this, solvents of fossil origin, notably aliphatic solvents, are chosen in particular as solvent 1 (see, for example, Kirk-Othmer Encyclopedia of Chemical Technology, “Perfumes”, John Wiley & Sons Inc., K. D. Perring, pp. 1 to 46 (2016) DOI: 10.1002/0471238961.1605180619030818.a01.pub3, and Ullmann's Encyclopedia of Industrial Chemistry, “Perfumes”, M. V. Ende, W. Sturm and K. Peters, Wiley-VCH Verlag GmbH & Co. KGaA, Weinheim, (2017) https://onlinelibrary.wiley.com/doi/epdf/10.1002/14356007.a19_171.pub2).

For example, n-hexane is often used on the industrial scale due to a low cost price and its ability to dissolve a great variety of products, including plant oils, flavourings, fragrances and colours. On the other hand, n-hexane is a non-renewable solvent which is not very environmentally friendly. Moreover, the nature of the extraction solvent can result in a chemical odour, such as a petroleum ether odour, which differs from the odour of the original solid natural material. Moreover, the odour is not always long-lasting over time.

It is thus of great interest to find an alternative process for preparing concretes and/or absolutes which uses, in its process, a preferably “green” extraction solvent instead of solvent of fossil origin such as n-hexane, and which in addition does not denature the odour of the absolute or which does not leave a “chemical” odour such as, for example, a petroleum ether, in the absolute.

In 1991, the concept of Green Chemistry was put forward. Its objective is to reduce or eliminate at source the use of hazardous substances in the design of new products. Subsequently, twelve principles of green chemistry were proposed, “Green Chemistry: Theory and Practice”, Oxford Science, New York, P. T. Anastas et al. (1998). The indicators of green chemistry, such as the E-factor or atom economy, make it possible to measure the various aspects of a chemical process by referring to the principles of green chemistry (see, for example, Kirk-Othmer Encyclopedia of Chemical Technology, Green Chemistry, Michael A. Matthews, Vol. 12, pp. 799 to 818, 19 Apr. 2013, https://doi.org/10.1002/0471238961.0718050513012020.a01, and ibid., Green Chemistry, Applications, Albert S. Matlack, pp. 1 to 33, https://doi.org/10.1002/0471238961.greematl.a01).

Natural material extraction with n-heptane has been described in order to obtain concretes and absolutes using n-heptane solvent of fossil origin and derived from a Commiphora wildii plant source (WO 2019/149701). However, the yields of concretes and absolutes are not always satisfactory with respect to the starting raw material. In addition, the odour may be less pleasant or further from that of the natural material with a “chemical” note. On the other hand the US patent application US 2018/305638 discloses a process for obtaining concrete and absolute, by extraction for eg. of Oman incense gum and a mixture of solvent undecane and tridecane. Nevertheless, the odors obtained from the solvents described in the US patent application are not always satisfactory, especially in terms of persistence, intensity, notes, and/or are far removed from the starting biomass.

It is also desirable to be able to extract a concrete and/or an absolute from fresh, withered or dry, solid natural material, notably plant material, using a preferably “green” solvent with no change in odour of the concrete and/or the absolute or an olfactory trace of the solvent which made it possible to extract said concrete(s) and absolute(s), in particular an odour of “non-natural” product, such as petroleum ether. Moreover, it is of great interest to obtain extraction yields which are very markedly improved in comparison with conventional extraction solvents.

These technical problems have been solved by the process of the invention.

Thus one subject of the invention is a process for preparing a perfume concrete and/or a perfume absolute employing at least one step of bringing into contact a) a first system of solvents comprising at least one linear or branched alkane solvent comprising at least 8 carbon atoms, particularly comprising at most 15 carbon atoms, more particularly comprising from 8 to 12 carbon atoms, having a boiling point at atmospheric pressure between 105° C. and 190° C.;

with:
b) one or more fresh, withered or dry solid natural materials chosen from:
   i) rose (Rosa platyrhodon, Rosa hesperrhodos, Rosa hulthemia and Rosa eurosa and more particularly Rosa centifolia and Rosa damascena) flowers, jasmine (Jasminum and more particularly Jasminum grandiflorum and Jasminum sambac) flowers, lavender flowers, lavandin (Lavandula stoechas, Lavandula hybrida, Lavandula angustifolia, formerly officinalis, and Lavandula latifolia and more particularly Lavandula hybrida abrial, Lavandula hybrida grosso, Lavandula hybrida reydovan, Lavandula hybrida sumian and Lavandula hybrida super) flowers, orange (Citrus sinensis or bitter orange Citrus aurantium L) blossom, tuberose (Agave polianthes or Polianthes tuberosa) flowers, ylang-ylang (Cananga odorata) flowers, violet (Viola odorata var. victoria) flowers, and mimosa (Acacia dealbata, Acacia decurrens) flowers;
   ii) geranium (Pelargonium with in particular Cicconium, Magnipetala, Parvulipetala, Paucisignata, and more particularly Pelargonium graveolens) stems and leaves, patchouli (Pogostemon cablin and Pogostemon heyneanus) stems and leaves and petitgrain (Citrus aurantium, more particularly Citrus aurantium ssp. amara, or Citrus var. bigaradia, or Citrus aurantium ssp. aurantium) stems and leaves;
   iii) fruits chosen from anise (Pimpinella anisum), coriander (Coriandrum sativum), caraway (Carum carvi), cumin (Cuminum cyminum) and juniper (Juniperus, more particularly Juniperus communis, Juniperus oxycedrus, Juniperus thurifera, Juniperus phoenicea L.);
   iv) citrus fruits such as bergamot (Citrus bergamia), varieties of lemon (Citronella, Citrus limonum), varieties of orange (Citrus sinensis L.), varieties of mandarin (Citrus reticulata), varieties of grapefruit (Citrus paradisi); preferably varieties of lemon, varieties of bergamot, varieties of mandarin, or varieties of grapefruit; preferably Citrus bergamia (bergamot), or Citrus paradisi (grapefruit);
   v) mace (Myristica fragrans) seeds, angelica (Angelica archangelica) seeds, celery (Apium graveolens) seeds and cardamom (Elettaria cardamomum) seeds, tonka (Dipteryx odorata) seeds or beans, vanilla (Vanilla planifolia) pods and/or seeds, preferably cardamom (Elettaria cardamomum) seeds;
   vi) angelica (Angelica archangelica) roots, vetiver (Vetiveria, and more particularly Vetiveria zizanioides, Vetiveria nemoralis and Vetiveria nigritana) roots and iris, particularly Iris germanica and Iris pallida, roots; vii) sandalwoods (Santalum and more particularly Santalum album, Santalum ellipticum, Santalum spicatum), rosewoods (Aniba rosaeodora), cedarwoods (Cedrus, more particularly Cedrus atlantica and Juniperus cedrus) and lignum vitae (Bulnesia sarmientoi, Guaiacum officinale and Guaiacum sanctum);
   viii) herbs and grasses chosen from tarragon (Artemisia dracunculus), lemongrass (Cymbopogon and more particularly Cymbopogon citratus), sage (Salvia and more particularly Salvia officinalis and Salvia sclarea), mint (Mentha and more particularly Mentha aquatica, Mentha canadensis, Mentha spicata) and thyme (Thymus, more particularly Thymus vulgaris and Thymus zygis);
   ix) spruce needles and twigs, fir (Abies and more particularly Abies alba) needles and twigs, rosemary (Salvia rosmarinus, formerly Rosmarinus officinalis) needles and twigs, and pine (Pinus and more particularly Pinus sylvestris) needles and twigs; and
   x) resins and balms derived from galbanum (Ferula galbaniflua or Ferula gummosa), elemi (Canarium and more particularly Canarium commune, Canarium luzonicum and Canarium indicum), benzoin (Styrax and more particularly Styrax tonkinensis and Styrax benzoin), myrrh (Commiphora myrrha or Commiphora molmol and Commiphora opobalsamum) and olibanum (Boswellia, more particularly Boswellia sacra);
it being understood that the seeds or beans v) can be with or without shells, preferably without shells.

Another subject of the invention is a concrete and/or an absolute obtained from the preparation process as defined above.

Another subject is a composition, in particular a cosmetic composition, comprising at least one concrete and/or at least one absolute, it being understood that said concrete(s) and/or said absolute(s) is (are) obtained by the preparation process as defined above.

Another subject of the invention is a method for treating keratin materials, in particular human keratin materials such as the skin, or human keratin fibres such as the hair, employing the application, to the keratin materials, of concrete(s) and/or of absolute(s) obtained from the preparation process as defined above, it being understood that the concrete(s) and/or the absolute(s) can be contained in a cosmetic composition.

Another subject of the invention is a method for perfuming a support i) such as:
keratin materials, in particular human keratin materials such as the skin, or human keratin fibres such as the hair,
textile materials such as natural materials, for instance cotton, linen, silk and wool, or synthetic materials, for instance polyamides such as nylon, polyesters, acrylics or elastanes, for instance Spandex® and Lycra®,
wood,
paper,
articles made of leather, such as shoes or gloves, and/or
the atmosphere ii) (room fragrances, wardrobe fragrances),
employing one or more concrete(s) as defined below and/or one or more absolute(s) as defined below, by applying or spraying the concrete(s) and/or the absolute(s) over the support(s) i) or into the ambient air ii), it being understood that the concrete and/or the absolute can be contained in a composition as defined below.

Another subject of the invention is the use of a system of solvent(s) a) comprising at least one alkane solvent comprising at least 8 carbon atoms, particularly at most 15 carbon atoms, more particularly comprising from 8 to 12 carbon atoms, said solvent(s) preferably having a boiling point at atmospheric pressure above or equal to 100° C. and particularly a boiling point at atmospheric pressure below or equal to 200° C., more particularly between 105° C. and 190° C., even more preferentially between 110° C. and 180° C., better still between 120° C. and 175° C., in order to extract a perfume concrete and/or a perfume absolute from fresh, withered or dry solid natural material(s) i) to x) b) as defined above, with no chemical odour such as a chemical solvent odour.

Another subject of the invention is the use of one or more concretes and/or of one or more absolutes which are obtained according to the preparation process as defined above for the perfuming of a support i) such as:
keratin materials, in particular human keratin materials such as the skin, or human keratin fibres such as the hair,
textile materials such as natural materials, for instance cotton, linen, silk and wool, or synthetic materials, for instance polyamides such as nylon, polyesters, acrylics or elastanes, for instance Spandex® and Lycra®,
wood,
paper,
articles made of leather, such as shoes or gloves, and/or
the atmosphere ii) (room fragrances, wardrobe fragrances),

It appears, unexpectedly, that the odours of the concrete(s) and/or absolute(s) according to the invention, in particular those floral odours or odours resulting from seeds, deteriorate only slightly and remain long-lasting over time, and/or after application to keratin materials, in particular to the skin or to keratin fibres such as the hair. In particular, the fragrance notes of concrete(s) and/or of absolute(s) according to the invention are and/or remain powerful over time. Furthermore, the concrete(s) and/or the absolute(s) obtained according to the process of the invention are relatively stable with regard to external attacks, such as light, temperature and/or sweat.

In addition, the concrete and/or absolute preparation process according to the invention makes it possible in particular to obtain concretes and/or absolutes with a very satisfactory yield (at least comparable to, possibly higher than, those obtained with solvents of petroleum origin, in particular aliphatic solvents such as n-heptane) and having odours very close to the starting solid natural raw materials, with no “non-natural” olfactory trace related to the solvent. For example, on the olfactory level, the vanilla absolute obtained by the process according to the invention has a characteristic odour of the dried vanilla pod without any solvent note, which is closer to the natural odour than that obtained with solvent extraction using aliphatic solvents such as n-hexane or n-heptane. The odorous extracts contained in the concretes and/or absolutes of the invention have an odour substantially similar to that of the starting plant raw material. The concretes and/or absolutes of the invention can be used in perfumery, in cosmetics and also for the perfuming of supports i) as described above or of the atmosphere.

For the purposes of the present invention and unless otherwise indicated:
The term “grinding”, also referred to as “comminution”, “attrition” or “crushing”, is understood to mean the operation consisting in dividing the solid natural material(s) down to the powder state, preferably fine powder state, preferably with a size of the particles of the powder of less than 900 μm; advantageously, the size of the particles is of between 10 μm and 500 μm.

The term “powder” means a composition in pulverulent form, which is preferably essentially free of dust. In other words, the particle size distribution of the particles is such that the weight content of particles which have a size of less than or equal to 50 micrometres (dust content), preferably less than or equal to 10 micrometres (dust content), is advantageously less than or equal to 5%, preferably less than 2% and more particularly less than 1% (particle size evaluated using a Retsch AS 200 Digit particle size analyser; oscillation height: 1.25 mm/screening time: 5 minutes). Advantageously, the size of the particles is between 10 μm and 500 μm. The “powder” of solid natural material(s) can be screened in order to obtain particles with upper limit sizes corresponding to the orifices or sizes of the meshes of the screen, particularly between 35 and 80 mesh (US). According to a particular embodiment of the invention, the size of the particles of the powder of solid natural material(s) is fine. According to the invention, this more particularly means a particle size of less than or equal to 900 μm. Preferentially, the powder is constituted of fine particles with a size of between 7 and 700 μm and better still between 100 nm and 500 μm.

A “dry” material is understood to mean a plant raw material from which water has been withdrawn; preferably, the moisture content, i.e. water content, is between 0% and 10%, preferably less than 5%, even more preferentially less than 2%, better still less than 1%, such as less than 0.5% by weight relative to the total weight of said solid material, optionally in powder form.

A “fresh” material is understood to mean the hydrated material from which water has not been withdrawn; it was preferably harvested a few hours to a few days (up to 15 days) before bringing into contact with the solvent(s) and kept at a compatible temperature and with a relative humidity enabling the water content in said material to be maintained with ±2% of water; preferably, the fresh materials have a water content of greater than 10% by weight of water relative to the total weight of said solid material, optionally in powder form. More preferentially, the fresh material(s) of the invention is (are) chosen from flowers, such as jasmine flowers, mimosa flowers, rose flowers, tuberose flowers, orange blossom and ylang-ylang flowers, and preferably these flowers are treated with the process of the invention in the day after picking, or in 2 to 5 days after picking, having taken care to have kept the flowers at a temperature of between 1° C. and 5° C.

A “withered” material is understood to mean a plant raw material which is a particular fresh material, of which the flowering is finished, and/or the dry material is stored for one to several days (up to 15 days) before being treated by the process according to the invention and from which, in addition, water has been withdrawn in an amount of less than 80% by weight, preferably of less than 50% by weight, such as 1% to 40% by weight, in particular 1% to 20% by weight. A “natural” material is understood to mean a raw material of plant origin.

A “perfume raw material” is understood to mean a material in the crude state extracted from nature comprising olfactory active principles used in perfumery, or in the preparation of perfumes.

A “perfume” is understood to mean a particular olfactory composition, highly concentrated, provided packaged and having a high olfactory concentration. A “perfume” is also understood to mean an eau de toilette, an eau de parfum or an eau de Cologne.

In general, perfumes are constituted of a mixture of perfumery ingredients which may also be classified into head notes, heart notes and base notes. The three notes correspond to the greater or lesser volatility of the ingredients of which they are composed: highly volatile head note, moderately volatile heart note and sparingly volatile base note.
(i) The head note, also called “top” note, is that which is first perceived by the sense of smell as soon as the perfume is in contact with the keratin material or any other substrate. However, it is the note which fades the fastest: it does not “last”. It is difficult to express the persistence time of this note, since it is very variable: from a few minutes to about ten minutes. It is essentially fresh and light. All the citrus notes belong in particular to this category. In perfumery, they are grouped under the generic term hesperidic notes, which include orange, lemon, grapefruit, bergamot, orange blossom, neroli, and the like. Mention will also be made of herbal notes, such as lavender, laurel, thyme or rosemary, and anise, menthol, aldehyde, and the like, notes. Mention will also be made of eucalyptus notes.
(ii) The heart note, sometimes also called “middle note”, has a persistence which lasts from a few tens of minutes to a few hours, but its main characteristic is that it is not perceived until after a few minutes. Thus, it “starts” just before the head note dies off. It begins to express itself while the head note is gradually fading away. It is represented essentially by floral, fruity or spicy scents: lily of the valley, honeysuckle, violet, magnolia, cinnamon, geranium, jasmine, rose, iris, raspberry, peach, and the like.
(iii) The base note, sometimes also called “bottom note”, gives a perfume its “durability”, persistence or staying power. It is perceptible several hours, indeed even several days, or even several weeks, after application onto clothing or onto a perfume blotter or scent strip, depending on the concentration of the perfume. Mention will be made, for example, of woods, roots, mosses, resins and animal or mineral substances, such as opoponax, musks, amber, sandalwood, benzoin, lichen, clove, sage, and the like. Mention will also be made of vanilla, patchouli, coumarin, and the like, notes.

The term “plant” is understood to mean the group of photosynthetic organisms, the cells of which have a wall constituted of cellulose.

The term “solid” is understood to mean that the raw material has a consistency which is not liquid at ambient temperature (25° C.) and atmospheric pressure (760 mmHg), that is to say a composition of high consistency, which retains its shape during storage. In contrast to “fluid” or “liquid” compositions, it does not flow under its own weight, while being able to be relatively soft.

A “solvent” is understood to mean a substance which is liquid at ambient temperature (25° C.) and at atmospheric pressure, which has the property of dissolving, diluting or extracting other substances without chemically modifying them and without itself being chemically modified.

An “organic solvent” is understood to mean an organic substance, preferably liquid at ambient temperature and atmospheric pressure, capable of dissolving or dispersing another substance without chemically modifying it.

For the purposes of the present invention, the term “anhydrous” is understood to mean a liquid phase with a water content of less than 5% by weight, preferably less than 2% by weight and even more preferably less than 1% by weight relative to the weight of said liquid phase, or indeed even less than 0.5% and notably free of water, the water not being added during the preparation of the liquid phase, but corresponding to the residual water supplied by the mixed ingredients.

A “system of solvents” is understood to mean just one solvent or a mixture of several solvents, preferably two or three solvents, if the system of solvents is a mixture of solvents; preferably, all the solvents are “green”.

When reference is made to the temperature of the boiling point of the system of solvents comprising a mixture of solvents, it is understood that the boiling point at atmospheric pressure of each solvent of said mixture must comply with the temperature in question, i.e. said solvent(s) each have a boiling point at atmospheric pressure above or equal to 100° C. and particularly a boiling point at atmospheric pressure below or equal to 200° C., more particularly between 105° C. and 190° C., even more preferentially between 110° C. and 180° C., better still between 120° C. and 175° C.

A “green” solvent is understood to mean a solvent which complies with at least one of the 12 principles of green chemistry.

For the purposes of the present invention, an “alkane solvent” is understood to mean a saturated acyclic hydrocarbon-based solvent comprising at least 8 carbon atoms, and particularly at most 15 carbon atoms, more particularly comprising from 8 to 12 carbon atoms.
an “alkyl radical” is a linear or branched, saturated hydrocarbon-based C₁-C₈ group, in particular C₁-C₆ group, preferably C₁-C₄ group, such as methyl, ethyl, n-propyl, isopropyl or i-propyl, n-butyl, isobutyl or i-butyl and tert-butyl or t-butyl;

The term “solid/liquid extraction” or “leaching” is understood to mean the process for completely or partially extracting one or more compounds of natural material in an appropriate solvent. Solid/liquid extraction (also symbolized by “liquid-solid”) covers a variety of extraction processes known to a person skilled in the art (see Extraction Liquid-Solid, Kirk-Othmer Encyclopedia of Chemical Technology, Richard J. Wakeman (2000); https://doi.org/10.1002/0471238961.1209172123011105.a01, and Extraction Liquid-Solid, Ullmann's Encyclopedia of Industrial Chemistry, T. Voeste et al., (2012) DOI: 10.1002/14356007.b03_07.pub2.

For the purposes of the present invention, the term “physiologically acceptable medium” is intended to denote a medium that is suitable for the topical administration of a composition. A physiologically acceptable medium is without unpleasant odour and/or unpleasant appearance and is entirely compatible with the topical administration route.

A “keratin material” is understood to mean the skin, the scalp, the lips and/or skin appendages such as the nails and keratin fibres, such as, for example, body hair, the eyelashes, the eyebrows and head hair.

For the purposes of the invention, a “cosmetic composition” means any composition applied to a keratin material to produce a non-therapeutic hygiene, care, perfuming, conditioning or makeup effect contributing towards improving the well-being and/or enhancing the beauty and/or modifying the appearance of the keratin material onto which said composition is applied.

For the purposes of the invention, a “dermatological composition” means any composition applied to a keratin material to prevent and/or treat a disorder or dysfunction of said keratin material.

For the purposes of the invention, a “cosmetic treatment” means any non-therapeutic fragrancing, hygiene, care, conditioning or makeup effect contributing towards improving the well-being and/or enhancing the beauty and/or modifying the appearance or odour of the keratin material onto which said composition is applied.

The term “high-frequency” ultrasound is understood to mean sound, the frequency of which is greater than 100 kHz and, for the very high frequencies, greater than 1 MHz;

The term “low-frequency” ultrasound is understood to mean sound, the frequency of which is between 16 and 100 KHz.

the Process for Preparing the “Concrete” and/or the “Absolute”:

According to a particular embodiment of the invention, the first step of the process for preparing the concrete and/or absolute can be preceded by the drying of the solid natural material(s) i) to x) as defined above and/or optionally by the grinding of natural material(s) i) to x) as defined above.

### Step of Drying Solid Natural Material

According to a particular embodiment of the invention, the natural material(s) i) to x) used in the process was (were), beforehand, washed and/or rinsed with water and/or dried in the open air or using conventional thermal means at a temperature preferably between 10° C. and 35° C., or else dehydrated in a thermal or microwave oven, or at ambient temperature using, for example, a desiccator, optionally under vacuum, in particular containing silica or P₂O₅, or using a dehydrator.

### Grinding Step

According to a particular embodiment of the invention, one or more grinding(s) is (are) carried out on the fresh or dry natural material(s) i) to x) as defined above before bringing into contact with the first solvent system a) as defined above to result in the mixture a)+b). More particularly, the grinding(s) is (are) carried out at ambient temperature (25° C.) or at low temperature; in particular at a temperature below 0° C., below −10° C., more particularly below −30° C., even more particularly at a temperature below −70° C., in particular using dry ice, liquid nitrogen or a mixture including dry ice and/or liquid nitrogen, such as the combination of methanol and liquid nitrogen.

The grinding(s) of the natural material(s) i) to x) can be mechanical, such as the grinding using a pestle and mortar, a ball mill, a cryogenic grinder, a yagen, a planetary mill, an analytical mill, notably an analytical knife mill, a knife mill (blender) or using an industrial grinder/micronizer or industrial crusher, preferably an analytical mill, notably an analytical knife mill.

The grinding time depends on the result which is desired in terms of fineness of the ground material; generally, it is between 1 second and 5 minutes with an analytical mill, notably an analytical knife mill, preferably between 10 seconds and 1 minute, more preferentially between 20 seconds and 40 seconds.

According to another particular embodiment of the invention, the grinding of the natural material(s) is carried out after treatment with liquid nitrogen.

Preferably, the grinding(s) is (are) mechanical. More particularly, the grinding(s) is (are) carried out at ambient temperature (25° C.). More preferentially, the grinding(s) is (are) carried out on seeds, with or without shells, with or without the pod, of natural material(s), in particular plant natural material(s). According to one embodiment, the grinding is carried out on seeds and/or pods v), preferably on pods v) such as vanilla pods, notably that have been dried.

If the quality of the powder after grinding is not sufficiently fine, that is to say that the particles have a size of greater than 500 μm, the grinding step can be repeated with the same appliance or on another grinding appliance, in particular a grinder/micronizer.

Ideally, the size of the powder obtained after grinding(s) is between 500 nm and 900 μm, more particularly between 100 nm and 500 μm. The size of the powder obtained after grinding(s) is preferably between 500 nm and 100 μm, more particularly between 100 nm and 50 μm.

The particle size of the powder is evaluated according to the light scattering analysis with a dry powder.

According to a preferred embodiment of the invention, the grinding(s) of natural material(s) is (are) carried out on seeds, with or without shells, with or without pod, preferably without shells. According to a particularly preferred embodiment, the grinding is carried out on seeds or pods v), preferably pods v) such as dried vanilla pods.

### the Natural Material(s) b):

The natural material(s) b) are chosen from:
i) flowers chosen from: the four subgenera Rosa platyrhodon, Rosa hesperrhodos, Rosa hulthemia and Rosa eurosa and more particularly Rosa centifolia and Rosa damascena (rose), Jasminum and more particularly Jasminum grandiflorum and Jasminum sambac (jasmine), Lavandula stoechas, Lavandula hybrida, Lavandula angustifolia, formerly officinalis and Lavandula latifolia and more particularly Lavandula hybrida abrial, Lavandula hybrida grosso, Lavandula hybrida reydovan, Lavandula hybrida sumian and Lavandula hybrida super (lavender and lavendin), blossom form the orange Citrus sinensis or from the bitter orange Citrus aurantium L (orange blossom), Agave polianthes or Polianthes tuberosa (tuberose flowers), Cananga odorata (ylang-ylang flowers) and mimosa flowers (Acacia dealbata or Acacia decurrens flowers);
ii) geranium or pelargonium, with in particular Cicconium, Magnipetala, Parvulipetala, Paucisignata and more particularly Pelargonium graveolens (geranium) stems and leaves, Pogostemon cablin and Pogostemon heyneanus (patchouli) stems and leaves and Citrus aurantium, more particularly Citrus aurantium ssp. amara, or Citrus var. bigaradia, or Citrus aurantium ssp. aurantium, (petitgrain) stems and leaves;
iii) fruits chosen from Pimpinella anisum (anise), Coriandrum sativum (coriander), Carum carvi (caraway), Cuminum cyminum (cumin) and Juniperus, more particularly Juniperus communis, Juniperus oxycedrus, Juniperus thurifera, Juniperus phoenicea L., (juniper);
iv) citrus fruits chosen from varieties of lemon, varieties of mandarin (Citrus reticulata), varieties of clementine (Citrus clementina), varieties of grapefruit, particularly bergamot (Citrus bergamia), lemon (Citronella, Citrus limonum), mandarin, such as Citrus reticulata, or of grapefruit (Citrus paradisi); preferably bergamot or grapefruit;
preferably Citrus bergamia (bergamot), or Citrus paradisi (grapefruit);
v) Myristica fragrans (mace) seeds, Angelica archangelica (angelica) seeds, Apium graveolens (celery) seeds and Elettaria cardamomum (cardamom) seeds, Dipteryx odorata (tonka) seeds or beans, Vanilla planifolia (vanilla, and/or vanilla pod, and/or vanilla seeds), preferably Elettaria cardamomum (cardamom) seeds, Dipteryx odorata (tonka) seeds or beans and Vanilla planifolia (vanilla and/or vanilla pod) and even more preferentially cardamom or vanilla, notably vanilla;
vi) Angelica archangelica (angelica) roots, Vetiveria, and more particularly Vetiveria zizanioides, Vetiveria nemoralis and Vetiveria nigritana (vertiver) roots and Iris, more particularly Iris germanica and Iris pallida (iris) roots;
vii) woods of Santalum and more particularly Santalum album, Santalum ellipticum, Santalum spicatum (sandalwood), woods of Aniba rosaeodora (rosewood), woods of Cedrus, more particularly Cedrus atlantica and Juniperus cedrus (cedarwood), and woods of Bulnesia sarmientioi, Guaiacum officinale and Guaiacum sanctum (lignum vitae);
viii) herbs and grasses chosen from Artemisia dracunculus (tarragon), Cymbopogon and more particularly Cymbopogon citratus (lemongrass), Salvia and more particularly Salvia officinalis and Salvia sclarea (sage), Mentha and more particularly Mentha aquatica, Mentha canadensis, Mentha spicata (mint) and Thymus, more particularly Thymus vulgaris and Thymus zygis (thyme); ix) spruce needles and twigs, needles and twigs of Abies and more particularly Abies alba (fir), needles and twigs of Salvia rosmarinus, formerly Rosmarinus officinalis (rosemary), and needles and twigs of Pinus and more particularly Pinus sylvestris (pine); and
x) resins and balms derived from Ferula galbaniflua or Ferula gummosa (galbanum), Canarium and more particularly Canarium commune, Canarium luzonicum and Canarium indicum (elemi), Styrax and more particularly Styrax tonkinensis and Styrax benzoin (benzoin), Commiphora myrrha or Commiphora molmol and Commiphora opobalsamum (myrrh) and Boswellia, more particularly Boswellia sacra (oliban).

Particularly iv), the citrus fruits of the invention, are such as the varieties of Citrus bergamia (bergamot), the varieties of Citronella, Citrus limonum (lemon), the varieties of Citrus reticulata (mandarin), the varieties of Citrus paradisi (grapefruit); preferably Citrus bergamia (bergamot) or Citrus paradisi (grapefruit).

According to a particular embodiment, the citrus fruits iv) of the invention are chosen from the varieties of lemon (Citronella, Citrus limonum), such as calamondin, bergamot, kumquat, citron, finger lime, yellow lemon, lime, makrut lime and yuzu, the varieties of mandarin (Citrus reticulata) and of clementine (Citrus clementina), such as Nova, Encorce, Fortune, Ortanique, Nour or MA3, Cassar, Hernandina, Marisol, Nules, Caffin, the varieties of grapefruit (Citrus maxima, Citrus grandis or Citrus paradisi), such as white or blood pomelo, white grapefruit, pink grapefruit, blood grapefruit; particularly bergamot (Citrus bergamia), lemon (Citronella, Citrus limonum), mandarin (Citrus reticulata) or grapefruit (Citrus paradisi); preferably bergamot (Citrus bergamia) or grapefruit (Citrus paradisi).

According to a particular embodiment, iv) is different from citrus fruit peel.

According to a further embodiment, the fresh, withered or dry solid natural material(s) is (are) chosen from the families i) to iii) and v) to x) as defined above and notably from the family v), even more particularly vanilla.

During the step of bringing a) into contact with b) of the process of the invention, it is preferred to use one or more fresh, withered or dry solid natural material(s) chosen from i) flowers, such as lavender, lavandin, jasmine, rose and orange blossom, and ii) seeds, with or without shells, such as cardamom, more preferably chosen from i), and even more particularly i) flowers from: Rosa platyrhodon, Rosa hesperrhodos, Rosa hulthemia and Rosa eurosa and more particularly Rosa centifolia and Rosa damascena (rose), Lavandula stoechas, Lavandula hybrida, Lavandula angustifolia, formerly officinalis and Lavandula latifolia and more particularly Lavandula hybrida abrial, Lavandula hybrida grosso, Lavandula hybrida reydovan, Lavandula hybrida sumian and Lavandula hybrida super (lavender and lavendin), blossom from the bitter orange Citrus aurantium L (orange blossom), and mimosa flowers (Acacia dealbata or Acacia decurrens flowers).

According to a particular variant of the invention, the fresh, withered or dry solid natural material(s) is (are) chosen from the materials i) as described above.

According to one embodiment, the fresh, withered or dry solid natural material(s) is (are) chosen from lavandin.

According to another embodiment, the fresh or dry solid natural material is jasmine flowers.

According to another embodiment, the fresh, withered or dry solid natural material is rose flowers.

According to another embodiment, the fresh, withered or dry solid natural material is tuberose flowers.

According to another embodiment, the fresh, withered or dry solid natural material is mimosa flowers.

According to another embodiment, the fresh or dry solid natural material is orange blossom.

According to another embodiment, the fresh or dry solid natural material is ylang-ylang flowers.

According to a second advantageous variant, the fresh or dry solid natural material(s) is (are) chosen from v) mace seeds, angelica seeds, celery seeds and cardamom (Elettaria cardamomum) seeds, tonka seeds or beans, vanilla pods or vanilla seeds, more preferably tonka seed or beans, vanilla pods or vanilla seeds, preferably vanilla pods or vanilla seeds, more preferentially dried vanilla pods, notably that have been ground.

According to another advantageous variant, the fresh or dry solid natural material(s) is (are) chosen from viii) herbs and grasses chosen from and especially needles and twigs of Salvia rosmarinus, formerly Rosmarinus officinalis (rosemary),

Preferably, the fresh, withered or dry solid natural raw material(s) chosen from b) is (are) chosen from the families chosen from i) and v) and notably chosen from the family v).

According to a particular embodiment of the invention, the fresh, withered or dry solid natural material(s) b) as defined above is (are) chosen from the botanical families resulting from flowers, stems and leaves, fruits, peels of citrus fruits, seeds, roots, wood, herbs and grasses, needles and twigs of trees chosen from Citrus bergamia (bergamot), Aniba rosaeodora (rosewood or Brazilian rosewood), family of Juniperus, Cupressus and Cedrus (cedarwood), Citronella (lemon), Eugenia caryophyllata (clove), Ferula gummosa (galbanum), Pelargonium graveolens (geranium), Jasminum officinale var. grandiflorum (jasmine), Lavandula hybrida, Lavandula angustifolia, formerly officinalis, and Lavandula latifolia (lavandin, lavender), Evernia prunastri (oakmoss), Iris pallida and Iris germanica (orris), Citrus aurantium subspecies amara (orange blossom), Pogostemon cablin (patchouli), C. aurantium (petitgrain), Rosa, in particular Rosa damascena and Rosa centifolia (rose), Santalum album (sandalwood), Vetiveria zizanoides (vetiver), Viola odorata var. victoria (violet), Cananga odorata (ylang-ylang), Vanilla planifolia (vanilla and/or vanilla pod) and Elettaria cardamomum (cardamom).

More preferentially, the fresh, withered or dry solid natural material(s) of the invention is (are) chosen from the following botanical families: Elettaria cardamomum (cardamom), Jasminum officinale var. grandiflorum (jasmine), Rosa, in particular Rosa damascena and Rosa centifolia (rose), Citrus aurantium subspecies amara (orange blossom), and Lavandula angustifolia, formerly officinalis, and Lavandula latifolia (lavandin, lavender), Vanilla planifolia (vanilla and/or vanilla pod) and Acacia dealbata, Acacia decurrens (mimosa) flower.

Preferably, the fresh, withered or dry solid natural raw material(s) is (are) chosen from the families chosen from i) and v). More preferentially chosen from v) notably vanilla pods and/or seeds, preferentially dried vanilla pods, notably that have been ground.

According to one particular embodiment, the solid natural raw material(s) b) is (are) dry, preferably chosen from the families i) and v), more preferentially from the family v) and even more preferentially the solid raw materials b) denote dry vanilla pods, notably that have been ground.

### the First System of Solvent(s) a)

According to a preferred embodiment of the invention, the first solvent system comprises at least one alkane solvent comprising between 8 carbon atoms and 15 carbon atoms, more particularly comprising from 8 to 12 carbon atoms, said solvent(s) preferably having a boiling point at atmospheric pressure above or equal to 100° C. and particularly a boiling point at atmospheric pressure below or equal to 200° C., more particularly between 105° C. and 190° C., even more preferentially between 110° C. and 180° C., better still between 120° C. and 175° C.

According to one embodiment of the invention, the solvent system a) comprises at least one alkane solvent chosen from the solvents of formula (I) and also the optical isomers thereof:

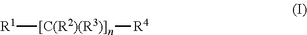

in which formula (I):
R¹ and R⁴, which are identical or different, represent a hydrogen atom or a (C₁-C₄) group such as methyl;
R² and R³, which are identical or different, represent a hydrogen atom or a (C₁-C₄) alkyl group such as methyl, preferably a hydrogen atom; and
n represents an integer between 1 and 15, particularly n is between 7 and 13, more particularly n is between 8 and 10,
it being understood that in total the solvent comprises between 8 and 15 carbon atoms, more preferentially between 9 and 13 carbon atoms, such as 12 carbon atoms.

As examples of alkane solvents of the invention, mention may be made of the solvents chosen from:
1) Octane (CAS No. 111-65-9), 2) nonane (CAS No. 111-84-2), 3) decane (CAS No. 124-18-5), 4) undecane (CAS No. 1120-21-4), 5) dodecane (CAS No. 112-40-3), 6) tridecane (CAS No. 629-50-5), 7) tetradecane (CAS No. 629-59-4), 8) pentadecane (CAS No. 629-62-9), 9) isododecane (CAS No. 31807-55-3), 10) isohexadecane (CAS No. 43-04-9), 11) n-hexadecane, 12) n-octadecane, 13) n-nonadecane, 14) hemisqualane, 15) isodecane, 16) C₈-C₉ isoparaffin, and 17) C₁₁-C₁₃ isoparaffin.

Particularly, the first solvent system according to the invention comprises at least one solvent chosen from: 1), 2), 3), 4), 5), 9), 15), 16), and 17), more particularly chosen from 1), 2), 3) and 9), more preferentially 9) isododecane.

According to one embodiment of the invention, the first solvent system does not comprise any n-hexane solvent, and more particularly does not comprise any alkane saturated hydrocarbon comprising a carbon number less than or equal to 7 carbon atoms. According to one embodiment of the invention, the first solvent system does not comprise any unsaturated hydrocarbon.

Preferentially, all the solvents used in the process of the invention are preferably “green” solvents.

The solvent(s) of the invention, if they comprise at least one asymmetric carbon, may be an enantiomerically pure (R) or(S), or in racemic form, or a mixture of these various forms, or a mixture of different (R) and(S) contents.

Preferably, the first solvent system comprises at least 50% by volume of at least one alkane solvent comprising at least 8 carbon atoms as defined above, notably the alkane solvent(s) is (are) chosen from the compounds of formula (I) and also the optical isomers thereof as defined above, relative to the total volume of the first solvent system. More preferentially at least 60% by volume of at least one alkane solvent comprising at least 8 carbon atoms as defined above, by volume relative to the total volume of the first solvent system. Even more preferentially, at least 80% by volume of at least one alkane solvent comprising at least 8 carbon atoms as defined above relative to the total volume of the first solvent system, better still at least 90% by volume of at least one alkane solvent comprising at least 8 carbon atoms as defined above relative to the total volume of the first solvent system, even better still 100% by volume of at least one alkane solvent comprising at least 8 carbon atoms as defined above relative to the total volume of the first solvent system.

More particularly, when the system of solvent(s) a) comprises one or more additional solvent(s) different from the alkane solvent comprising at least 8 carbon atoms as defined above, all the additional solvents are preferably “green”.

According to a particular embodiment, the additional solvent(s) are chosen from:
(A) polar protic solvents or protogenic solvents i.e. solvents having one or more hydrogen atoms capable of forming hydrogen bonds. Mention may be made of water and (C₁-C₈) alkanols with the alkane group being linear or branched, in particular alcohols such as bioethanol, 1-propanol, isoamyl alcohol, 2-pentanol or isopropanol;
(B) polar aprotic solvents i.e. solvents having a non-zero dipole moment and devoid of hydrogen atoms capable of forming hydrogen bonds. Mention may for example be made of esters of organic acids such as ethyl acetate, isopropyl acetate, propyl acetate, t-butyl acetate, isobutyl acetate, methyl propionate, methyl butyrate, methyl isobutyrate, methyl isovalerate or methyl 2-methylbutyrate, ketones such as methyl ethyl ketone or methyl propyl ketone and C₁-C₄ alkyl carbonates, such as dimethyl carbonate; and
(C) non-polar aprotic solvents, i.e. having a zero permanent dipole moment, which are different from the alkane solvent(s) comprising at least 8 carbon atoms as defined above. For example, hydrocarbons: linear or branched alkanes, cyclic alkanes, alkenes, comprising at most 7 carbon atoms.

Preferably, the additional solvent(s) are chosen from (A), (B) and the mixture thereof.

More particularly, the preferably “green” additional solvents different from the alkane solvent(s) comprising at least 8 carbon atoms as defined above of the invention are chosen from the following families:
esters of organic acids, such as ethyl acetate, isopropyl acetate, propyl acetate or t-butyl acetate, preferably isopropyl acetate;
alcohols such as bioethanol or isopropanol;
ketones such as methyl ethyl ketone or methyl propyl ketone;
C₁-C₄ alkyl carbonates, such as dimethyl carbonate;
and mixtures thereof.

According to one embodiment of the invention, the system of solvent(s) a) of the process is devoid of dimethyl carbonate. More particularly, the process of the invention does not employ dimethyl carbonate.

According to a particular embodiment, the first system of solvents has a density of less than 2, and in particular of less than or equal to 1.5, preferably of between 0.7 and 1.5.

Each of the solvents used in the system of solvents a) has a purity of at least 95%, notably of at least 97%, in particular of at least 99%.

Bringing the System of Solvent(s) a) into Contact with b) Solid Natural Material(s)

According to a particular embodiment of the invention, the solid natural material(s) i) to x), ground or unground, in the form of preferably dry powder(s), as defined above, is (are) brought into contact a) with a first system of solvent(s), as defined above, to form a heterogeneous a)+b) mixture.

According to another particular embodiment of the invention, the solid natural material(s) i) to x), in particular the materials i) as defined above, are used fresh is (are) brought into contact a) with a first system of solvent(s), as defined above, to form a heterogeneous a)+b) mixture.

More particularly, the contacting operation is carried out at ambient temperature, with or without stirring, preferably with stirring. The natural material(s) i) to x) as defined above is (are) more particularly left to macerate or infuse at a temperature of between 10° C. and 40° C., better still between 20° C. and 30° C., for instance 20° C., in the system of solvent(s) as defined above. According to another form of the invention, the contacting operation is carried out with heating at a temperature from at least 1° C. to 5° C. below or equal to the boiling point of the solvent having the lowest boiling point, for instance 30° C. Whatever the temperature at which a) is brought into contact with b), this contacting operation is carried out in a round-bottomed flask made of glass or of metal, an industrial or non-industrial stainless steel vessel, having a single wall or a jacket, or any other reactor suitable for receiving solvents and natural materials. The duration of maceration or infusion of said a)+b) mixture is preferably between a few seconds and a week, more particularly between 30 minutes and 48 hours, even more particularly between 1 hour and 36 hours, better still between 2 hours and 24 hours, even better still between 2 hours and 6 hours. The maceration or infusion can be carried out with stirring, i.e. the a)+b) mixture can be kept stirred mechanically, preferably at a rotational speed of between 10 rpm and 1200 rpm, in particular between 100 rpm and 900 rpm, even more particularly between 200 rpm and 850 rpm, for instance 200 rpm.

According to a particular embodiment of the invention, in the contacting operation the mass ratio between the solvent(s)/natural material(s) (especially biomass(es)) is between 1/1 to 20/1, preferably between 5/1 and 10/1, such as 9/1.

According to one embodiment, after mixing a)+b), said mixture is subjected to a sonication step, in particular by putting said mixture in a high- or low-frequency ultrasonic bath, preferably at frequencies of between 5 and 40 KHz. Preferably, the sonication time is of between 5 seconds and 1 hour, more preferentially of between 10 seconds and 30 minutes, more preferentially still between 30 seconds and 10 minutes, such as 5 minutes. The temperature during this sonication step is between 0° C. and 90° C., preferably between 5° C. and 30° C.

According to one embodiment, after mixing a)+b), a sonication of said mixture is optionally carried out as defined above; followed by a step of heating said mixture at a temperature above 20° C., particularly above 30° C., more particularly at a temperature above 35° C., even more particularly up to reflux of the or said solvent(s) of the system of solvents; preferably said mixture is heated at a temperature of between 40° C. and 100° C. Preferentially, the a)+b) mixture is heated for a period of time of between 5 minutes and 48 hours, particularly between 30 minutes and 24 hours, more particularly between 1 hour and 12 hours, even more preferentially between 2 hours and 5 hours.

The a)+b) mixture can be kept stirred mechanically, preferably at a rotational speed in particular of between 10 rpm and 1200 rpm, in particular between 100 rpm and 900 rpm, more particularly still between 200 rpm and 850 rpm, for instance 200 rpm.

According to a particular embodiment, during the heating of the mixture, the reactor in which the a)+b) mixture is found comprises a cooling system or condenser for cooling and condensing the solvent(s) of the system of solvent(s) a). More preferentially, the reactor is an extractor of Soxhlet type or a reactor provided with a mechanical stirrer and equipped with a water-cooled or helical condenser, preferably a reactor provided with a mechanical stirrer and equipped with a water-cooled or helical condenser. In the latter case, the system of solvent(s) is advantageously brought to reflux of said solvent(s) of the system of solvent(s), comprising at least one alkane solvent as defined above, to a temperature above or equal to 30° C. Preferentially, the a)+b) mixture is heated for a period of time of between 5 minutes and 48 hours, particularly between 30 minutes and 24 hours, more particularly between 1 hour and 12 hours, even more preferentially between 2 hours and 5 hours.

According to a particular embodiment of the invention, after the step of heating the a)+b) mixture, the mixture is allowed to return to ambient temperature or cooled to ambient temperature and is left, optionally under mechanical stirring as defined above, particularly between 30 minutes and 48 hours, more particularly still between 1 hour and 36 hours, better still between 2 hours and 24 hours.

More particularly, the contacting step is a “solid/liquid extraction” step.

According to a particular embodiment, the solid/liquid extraction step is carried out by means of a Soxhlet extractor. In the latter case, the system of solvents is advantageously brought to reflux of said solvent(s) of the system of solvent(s), in particular at a temperature above or equal to 30° C.

According to a particular embodiment, the solid/liquid extraction step is carried out by means of a reactor provided with a mechanical stirrer and equipped with a water-cooled or helical condenser. In the latter case, the system of solvents is advantageously brought to reflux of said solvent(s) of the system of solvent(s), in particular at a temperature above or equal to 30° C.

According to another variant when for example the plant natural material(s) is (are) flowers, notably jasmine flowers, mimosa flowers, or vanilla seeds and/or pods, notably that have been dried, preferably dried and ground, the system of solvents is not brought to reflux, but maintained at a temperature at least 1° C. to 5° C. below or equal to the boiling point of the solvent having the lowest boiling point, below or equal to 45° C., such as 40° C. The contacting and solid/liquid extraction step is followed by a step of recovering the natural extract, preferably plant natural extract, resulting from the natural material(s), preferably plant natural material(s). This recovery can be carried out by filtration, distillation or with an extractor of Soxhlet type. According to one embodiment, the recovery is carried out by filtration for example on paper.

The solvent(s) of the extract(s) can be removed by desolventization. Mention may be made, for example, as desolventization process, of the evaporation of solvent(s), preferably under vacuum, for example using a rotary evaporator combined with a vacuum pump, an industrial evaporator, or else with a distillation apparatus, in order to obtain, after separation, extraction and evaporation of the solvent(s), a perfume concrete.

According to another variant of the process of the invention, the step of recovering the extract is carried out by separation of the natural material(s) which has (have) not been dissolved (also called precipitate) from its supernatant comprising said solvent(s). The separation of the precipitate from the solvent(s) is carried out by conventional methods known to a person skilled in the art. Mention may be made, for example, of the filtration method, or chromatography. The solvent(s) can be removed from the supernatant by desolventization as defined above; if need be, said desolventized supernatant can be purified again by one or more conventional purification method(s) known to a person skilled in the art. Mention may be made, for example, of chromatography, distillation, optionally under reduced pressure, and/or recrystallization, in order to obtain a concrete. The concrete is relatively viscous and may be in the form of a thick waxy, optionally coloured, residue.

According to a particular embodiment, the preparation process of the invention is a process for preparing a perfume concrete employing:
1) at least one step of bringing:
   a) a first system of solvents comprising at least one alkane solvent comprising at least 8 carbon atoms as defined above, notably, the alkane solvent(s) is (are) chosen from the compounds of formula (I) and also the optical isomers thereof as defined above; into contact with
   b) one or more solid natural material(s) chosen from i) to x) as defined above; then
2) the a)+b) mixture is optionally subjected to a sonication step, in particular by putting said mixture in an ultrasonic bath; preferably, the sonication time is of between 5 seconds and 1 hour, more preferentially of between 10 seconds and 30 minutes, even more preferentially between 30 seconds and 10 minutes, for instance 5 minutes;
3) followed by a step of heating the a)+b) mixture at a temperature above 30° C.; preferably, the reactor in which the a)+b) mixture is found comprises a cooling system or condenser; more preferentially, the reactor is an extractor of Soxhlet type or a distillation apparatus; preferentially, the a)+b) mixture is heated for a period of time of between 5 minutes and 48 hours, particularly between 30 minutes and 24 hours, more particularly between 1 hour and 12 hours, even more preferentially between 2 hours and 5 hours;
then
4) the solvent(s) of the extract is (are) removed, preferably under vacuum, for example using a rotary evaporator combined with a vacuum pump, an industrial evaporator, or else with a distillation apparatus, to result in the concrete; or else the natural material(s) which has (have) not been dissolved is (are) separated from its (their) supernatant(s), the separation being carried out preferably by filtration or by chromatography; the supernatant(s) can subsequently be separated and recovered and the solvent(s) of said supernatant(s) is (are) removed by evaporation of solvents as defined above, to result in the concrete.

According to a preferred embodiment, the preparation process of the invention is a process for preparing a perfume concrete employing:
1) at least one step of bringing:
   a) a first system of solvents comprising at least one alkane solvent comprising at least 8 carbon atoms as defined above, notably, the alkane solvent(s) is (are) chosen from the compounds of formula (I) and also the optical isomers thereof as defined above; into contact with
   b) one or more solid natural material(s) chosen from i) to x) as defined above, preferably v); then
2) the a)+b) mixture is optionally subjected to a sonication step, in particular by putting said mixture in an ultrasonic bath; preferably, the sonication time is of between 5 seconds and 1 hour, more preferentially of between 10 seconds and 30 minutes, even more preferentially between 30 seconds and 10 minutes, for instance 5 minutes;
3) the system of solvents is maintained at a temperature at least 1° C. to 5° C. below or equal to the boiling point of the solvent having the lowest boiling point, particularly at a temperature below or equal to 45° C., such as 40° C. and preferably below the boiling temperature of the first solvent system a); the contacting and solid/liquid extraction step is followed by a step of recovery of the natural extract, preferably plant natural extract, resulting from the natural material(s), preferably plant natural material(s); this recovery can be carried out by filtration, distillation, or with a Soxhlet extractor, preferably by filtration for example on paper; preferentially the a)+b) mixture is maintained at a temperature below or equal to 45° C., for a time of between 5 minutes and 48 hours, particularly between 30 minutes and 24 hours, more particularly between 1 hour and 12 hours, even more particularly between 2 hours and 5 hours; then
4) the solvent(s) of the extract is (are) removed, preferably under vacuum, for example using a rotary evaporator combined with a vacuum pump, an industrial evaporator, or else with a distillation apparatus, to result in the concrete; or else the natural material(s) which has (have) not been dissolved is (are) separated from its (their) supernatant(s), the separation being carried out preferably by filtration or by chromatography; the supernatant(s) can subsequently be separated and recovered and the solvent(s) of said supernatant(s) is (are) removed by evaporation of solvents as defined above, to result in the concrete.

The concrete(s) obtained with the process of the invention can also be used or packaged in a wax or in a natural fatty substance.

### the Second System of Solvent(s)

According to an advantageous variant in the process of the invention, the concrete is brought into contact with at least one second system of polar solvent(s), preferably polar protic solvent(s), comprising at least one polar protic solvent, in particular (C₂-C₆) alkanol, which is (are) “green” or of natural origin, such as bioethanol.

According to one embodiment of the invention, the second system of solvent(s) comprises at least one polar protic solvent, in particular chosen from (C₂-C₆) alkanols, which are “green” or of natural origin, such as bioethanol, in an amount representing at least 10% by volume relative to the total volume of the second solvent system, more preferentially at least 30%, even more preferentially at least 60%, preferably at least 80%, better still at least 90% by weight, even better still 100% by weight relative to the total volume of the second solvent system. When the second solvent system comprises a solvent mixture, preferably the solvent system comprises two solvents and the preferred additional solvent is of the same polarity as the first solvent and is miscible with the first solvent; more particularly, the second solvent of the second solvent system is water. Preferably, there is only a single solvent in the second solvent system, which is ethanol, more particularly bioethanol.

According to an advantageous variant of the invention, once the second system of polar protic solvent(s) has been added to the concrete, the concrete+solvent(s) mixture is maintained at a temperature below 0° C., more preferentially below or equal to −10° C. Subsequently, the pellet is separated from the supernatant, preferably by centrifuging, then the solvent(s) is (are) evaporated from the supernatant, preferably under vacuum, for example using a rotary evaporator combined with a vacuum pump, an industrial evaporator, or else with a distillation apparatus, in order to obtain, after separation, and evaporation of the solvent(s), a perfume absolute.

According to another variant, the step of bringing the concrete into contact with the second system of solvent(s) can be carried out with or without stirring, preferably with stirring. The operation of bringing the concrete into contact with the second system of solvent(s) can be carried out at a temperature of between 10° C. and 37° C., such as 20° C., in the system of solvent(s) as defined above, or at a temperature 1° C. to 5° C. below or equal to the boiling point of the solvents having the lowest boiling point, in a round-bottomed flask made of glass or of metal (stainless steel), an industrial or non-industrial vessel made of glass or of metal (stainless steel), or any other reactor suitable for receiving solvents, natural materials and concrete.

The duration of the operation of bringing the concrete into contact with the second system of solvent(s) is preferably between a few seconds and 2 days, more particularly between 5 minutes and 24 hours, even more particularly between 10 minutes and 12 hours, better still between 15 minutes and 2 hours.

According to a particular embodiment of the process of the invention, the operation of bringing the concrete into contact with the second system of solvent(s) is followed by a sonication step, in particular by putting said mixture in an ultrasonic bath. Preferably, the sonication time is of between 5 seconds and 1 hour, more preferentially of between 10 seconds and 30 minutes, even more preferentially between 30 seconds and 10 minutes, such as 5 minutes.

According to a preferred embodiment, the mixture of the concrete and of the second system of solvent(s) is maintained at a temperature below 0° C., more preferentially below or equal to −10° C., for a period of time of between 5 minutes and 48 hours, particularly between 5 minutes and 24 hours, more particularly between 5 minutes and 2 hours, even more preferentially between 5 minutes and 1 hour. Subsequently, the pellet is separated from the supernatant, preferably by centrifuging, then the solvent(s) is (are) evaporated from the supernatant, preferably under vacuum, for example using a rotary evaporator combined with a vacuum pump, an industrial evaporator, or else with a distillation apparatus, in order to obtain, after separation, and evaporation of the solvent(s), a perfume absolute.

According to a variant of the process of the invention, the step of recovery of the absolute is carried out by separation of the precipitate of the concrete which has not been dissolved in the second system of solvent(s) and of its supernatant comprising said solvent(s) of the second system of solvent(s).

The separation of the precipitate of the concrete and of the supernatant is carried out by conventional methods known to a person skilled in the art. Mention may be made, for example, of the filtration method, or chromatography.

The solvent(s) of the second system of solvent(s) can be removed from the supernatant by desolventization as defined above, preferably by evaporation under reduced pressure; if need be, said desolventized supernatant can be purified again by a conventional purification method known to a person skilled in the art. Mention may be made, for example, of chromatography, distillation, optionally under reduced pressure, and/or recrystallization, in order to obtain an absolute.

The absolutes are generally viscous and oily, optionally coloured, materials.

According to a particular embodiment of the invention, the concretes and absolutes, both obtained by total extraction of plant solid natural material and not being subjected to any form of distillation other than the removal of the solvents by desolventization, are complex mixtures containing numerous chemical types over a broad weight scale. Even if the volatile materials comprise only a very small part of the total, the concretes and absolutes obtained with the process of the invention have powerful odours and contribute to the perfumes in which they are used. Furthermore, the odours are long-lasting.

### The Composition:

Another subject of the invention is a composition, in particular a cosmetic composition, preferably a perfuming composition, comprising at least one concrete and/or at least one absolute, it being understood that said concrete(s) and/or said absolute(s) is (are) obtained by the preparation process as defined above.

According to one embodiment, the composition of the invention contains one or more concrete(s) obtained with the preparation process as defined above.

According to a preferred embodiment, the composition of the invention contains one or more absolute(s) obtained with the preparation process as defined above.

The cosmetic compositions according to the invention are cosmetically acceptable, i.e. they comprise only ingredients which are cosmetic ingredients, i.e. which do not detrimentally affect keratin materials and which are suitable for a cosmetic use.

According to one particular embodiment of the invention, the composition is anhydrous. When the composition is anhydrous, it generally comprises one or more fatty substances, which are liquid at 25° C. and atmospheric pressure, pasty substances, or substances in the form of waxes. The liquid fatty substances, pasty substances and waxes are more particularly as defined below.

According to another embodiment of the invention, the composition is aqueous. Generally, the compositions of the invention comprise a support which generally contains water or a mixture of water and of one or more organic solvents or a mixture of organic solvents; preferably, the organic solvent(s) is (are) “green”.

### Organic Solvents:

Examples of organic solvents that may be mentioned include C₂-C₄ lower alkanols, such as ethanol and isopropanol; polyols and polyol ethers such as 2-butoxyethanol, propylene glycol, propylene glycol monomethyl ether, diethylene glycol monoethyl ether, diethylene glycol monomethyl ether, hexylene glycol, and also aromatic alcohols, such as benzyl alcohol or phenoxyethanol.

According to a particular embodiment, the perfuming composition is aqueous. More particularly, it is an aqueous-alcoholic composition comprising (C₂-C₄) alkanols which are more particularly “green”, preferably ethanol which is more preferentially “green”, such as bioethanol. The amount of organic solvent, which is preferably “green”, and in particular of (C₂-C₄) alkanols, is preferably of between 1% by weight and 80% by weight, more particularly between 5% and 50% by weight, preferentially between 10% and 30% by weight, with respect to the total weight of the perfuming composition.

According to a particular embodiment, the organic solvents, which are preferably “green”, and in particular the (C₂-C₄) alkanols, are present in proportions of between 1% and 40% by weight approximately relative to the total weight of the composition, and even more preferentially between 5% and 30% by weight approximately.

### Adjuvants:

The composition(s) of the invention may also contain various adjuvants conventionally used in cosmetic compositions, such as anionic, cationic, nonionic, amphoteric or zwitterionic emulsifiers or surfactants or mixtures thereof, anionic, cationic, nonionic, amphoteric or zwitterionic polymers or mixtures thereof, mineral or organic thickeners, and in particular anionic, cationic, nonionic and amphoteric polymeric associative thickeners, antioxidants, penetrants, sequestrants, fragrances other than those of the concrete or absolute of the invention, antiperspirants, buffers, dispersants, conditioning agents, film-forming agents, ceramides, preserving agents, opacifiers and fatty substances, notably oils.

The above adjuvants are generally present in an amount for each of them of between 0.01% and 40% by weight relative to the weight of the composition, and preferably between 0.1% and 20% by weight relative to the weight of the composition.

Of course, a person skilled in the art will take care to choose this or these optional additional compound(s) in such a way that the advantageous properties intrinsically attached to the composition(s) of use in the method for perfuming or treating keratin materials in accordance with the invention are not, or not substantially, detrimentally affected by the envisaged addition(s).

The compositions according to the invention may be packaged in the form of bottles. They can also be applied in the form of fine particles by means of pressurization devices. The devices in accordance with the invention are well known to a person skilled in the art and comprise non-aerosol pumps or “atomizers”, aerosol containers comprising a propellant and also aerosol pumps using compressed air as propellant. The latter are described in U.S. Pat. Nos. 4,077,441 and 4,850,517.

The compositions packaged as an aerosol in accordance with the invention generally contain conventional propellants, such as, for example, hydrofluorinated compounds, dichlorodifluoromethane, difluoroethane, dimethyl ether, isobutane, n-butane, propane or trichlorofluoromethane, preferably isobutane, n-butane or propane.

The compositions according to the invention may be in any presentation form conventionally used for topical application and notably in the form of aqueous or aqueous-alcoholic solutions, of oil-in-water (O/W), water-in-oil (W/O) or multiple (triple: W/O/W or O/W/O) emulsions, of aqueous gels, of dehydrated anhydrous products, such as free or compact perfuming powders, or of dispersions of an oily phase in an aqueous phase using lipid vesicles of ionic type (liposomes) and/or nonionic type. These compositions are prepared according to the usual methods.

In addition, the compositions according to the invention may be more or less fluid and may have the appearance of a liquid, a cream, an ointment, a milk, a lotion, a serum, a paste or a foam. They may also be in solid form, for example in the stick form.

When the composition according to the invention comprises an oily phase, it preferably contains at least one oil, in particular a physiologically acceptable oil. It may contain fatty substances other than oils, in particular plant oils, more preferentially natural oils.

### the Method for Treating Keratin Materials:

Preferably, the method for treating keratin materials of the invention is a method for treating human keratin materials, such as the skin, or human keratin fibres, such as the hair, employing the application of one or more concrete(s) and/or of one or more absolute(s), by application of the concrete(s) and/or of the absolute(s) obtained from the preparation process as defined above, it being understood that said concrete(s) and/or the absolute(s) can be contained in a composition as defined above.

More preferentially, the method for treating keratin materials of the invention is a method for treating human keratin materials, such as the skin, or human keratin fibres, such as the hair, employing the application of one or more absolute(s) obtained from the preparation process as defined above, it being understood that the absolute(s) can be contained in a composition as defined above.

The invention will now be described with reference to the examples that follow, which are given as non-limiting illustrations. In these examples, unless otherwise indicated, the amounts are expressed as percentages by weight. The following scented compositions were prepared; the amounts are shown as percentages by weight.

### EXAMPLES

### Examples 1 to 7 and Comparative Examples 8 and 9

### Solvents

Ethanol denotes 96% ethanol.

Vanilla, or Vanilla planifolia, belongs to the family Orchidaceae.

The flowers, joined in groups of 8 to 10, resemble those of numerous orchids. They are scented and white or green-yellow in colour. Vanilla flowers in autumn-winter between September and January, depending on the cultivation zone. It produces long stems of violet-scented flowers.

The ripe fruit is completely odourless; its unique and valued odour is acquired after a fermentation process. This valued fruit owes its characteristic odour to the odorous principle called vanillin. The fruits or pods alone are used for the extraction. The dried biomass, finely ground with a grinder of IKAA11 mill type (size of a few millimetres), is ready for use and is then brought into contact with the various solvents, with a 1:10 ratio (1 g of dry biomass per 10 ml of solvent) in a RADLEYS® 1 L jacketed reactor. The heterogeneous reaction medium is subsequently stirred (6500 rpm) at ambient temperature and is then brought to 50° C. for 2 hours. The reaction medium is subsequently allowed to return to ambient temperature.

### Experimental Protocol 1

20 g of dried vanilla pods are pre-ground, and placed in a 500-ml round-bottomed flask. The extraction solvent (180 g) is then added to the biomass. The round-bottomed flask is then positioned on a Rotavapor system, the round-bottomed flask dipping into the bath thermostatically maintained at 20° C. (RT). Said round-bottomed flask is then placed under stirring (200 rpm) for 2 hours. The mixture is then filtered over a pleated filter then the solvent is evaporated until a coloured residue corresponding to the concrete is obtained. The latter is then taken up in ethanol (30 ml) at low temperature in order to precipitate the waxes. After separating the latter in the centrifuge (3000 rpm, 15 min at 19° C.), the supernatant is drawn off then evaporated under vacuum to result in the absolute.

### Experimental Protocol 2

20 g of dried vanilla pods are pre-ground, and placed in a 500-ml round-bottomed flask. The extraction solvent (180 g) is then added to the biomass. The round-bottomed flask is then positioned on a Rotavapor system, the round-bottomed flask dipping into the bath thermostatically maintained at 40° C. The round-bottomed flask is then placed under stirring (200 rpm) for 2 hours. The mixture is then filtered over a pleated filter then the solvent is evaporated until a coloured residue is obtained in order to result in the concrete. The latter is then taken up in ethanol (30 ml) at low temperature in order to precipitate the waxes. After separating the latter in the centrifuge (3000 rpm, 15 min at 19° C.), the supernatant is drawn off then evaporated under high vacuum to result in the absolute.

Vanilla, or Vanilla planifolia, belongs to the family Orchidaceae. The tests of Examples 1 to 7 are carried out with alkane solvents on the vanilla (Vanilla patifolia) extract according to the experimental protocols prot. 1 and prot. 2, Examples 4 and 5 being comparative examples with the comparative solvents 1 and 2.

### Preparation of the Solid Natural Material:

TABLE 1

| | | | | Weight | | Weight | Amount raw | |
|---|---|---|---|---|---|---|---|---|
| | Solvent | Chemical | | of | | of | mat. diluted | |
| Ex. | (Solv.) | name | Prot. | concrete | | absolute | (30% ethanol) | |
| 1 | 9) | Isododecane - | 2 | 1.59 | g | 0.99 g | 3.3 | g |
| | | CAS No. | | | | | | |
| | | 31807-55-3 | | | | | | |
| 2 | 1) | n-Octane - | 1 | 1.33 | g | 1.19 g | 3.93 | g |
| | | CAS No. | | | | | | |
| | | 111-65-9 | | | | | | |
| 3 | 1) | n-Octane - | 2 | 1.91 | g | 1.05 g | 3.49 | g |
| | | CAS No. | | | | | | |
| | | 111-65-9 | | | | | | |
| 4 | 2) | n-Nonane - | 1 | 1.28 | g | 1.18 g | 3.92 | g |
| | | CAS No. | | | | | | |
| | | 111-84-2 | | | | | | |
| 5 | 2) | n-Nonane - | 2 | 1.41 | g | 1.34 g | 4.45 | g |
| | | CAS No. | | | | | | |
| | | 111-84-2 | | | | | | |
| 6 | 3) | n-Decane - | 1 | 1.46 | g | 0.81 g | 2.7 | g |
| | | CAS No. | | | | | | |
| | | 124-18-5 | | | | | | |
| 7 | 3) | n-Decane - | 2 | 1.7 | g | 0.96 g | 3.2 | g |
| | | CAS No. | | | | | | |
| | | 124-18-5 | | | | | | |
| 8 | Comp. 1 | n-Heptane | 1 | 0.6 | g | 0.75 g | 2.5 | g |
| 9 | Comp. 2 | n-Heptane | 2 | 1.04 | g | 0.85 g | 2.38 | g |

The solvents comp. 1 and comp. 2 are comparative solvents outside of the invention.

It appears that the concretes and absolutes obtained with the process according to the invention (ex. 1 to 7) have an equivalent or even higher yield than those obtained with the solvents outside of the invention (ex. 8 and 9). Moreover, the vanilla absolutes obtained with the solvents of the invention are significantly better than those obtained with n-heptane (more fruity, less animal, more gourmand with a grilled note with the absolute of the invention), identical, on the olfactory level, to the fragrance of the vanilla starting raw material.

### Example 10

Preparation of the solid natural material: Lavandin, or Lavandula augustifolia, belongs to the Lamiaceae family.

This plant produces long stems of fragrant purple flowers. These are collected and then used for extraction. The stem is not used in order to avoid obtaining an overly herbaceous perfume note. The ready-to-use biomass is then brought into contact with the solvent, octane (CAS No. 111-65-9-solvent 1) with a 1:9 ratio (1 g of biomass for 9 mL of solvent) in a single neck flask with a capacity of 500 ml. The heterogeneous reaction medium is then stirred (6500 rpm) at room temperature and then warmed to 40° C. for 2 hours. The reaction medium is then left to return to ambient temperature.

At the end of the extraction, the dark macerate is recovered and can be filtered in order to remove the biomass residues, then can be placed in a rotary evaporator under high vacuum in order to eliminate the residual solvents. A viscous liquid is obtained.

The latter is then taken up with absolute ethanol (ratio 0.5/30 (0.5 g of Concrete for 30 g of ethanol)); the alcoholic medium is kept in an ice bath at about −10° C. for half an hour in order to precipitate the waxes in particular, before being centrifuged in an Eppendorf® 5810R centrifuge at 23° C. at 4000 rpm for 15 minutes. The supernatant is then placed in a flask to be placed in the rotary evaporator in order to remove the ethanol. Subsequently, the viscous liquid obtained can be placed in a desiccator under vacuum at 40° C. for half an hour in order to eliminate any trace of residual solvents. The absolute is then obtained.

The following test with lavandin biomass was carried out:

TABLE 3

| | | | | | Amount raw mat. |
|---|---|---|---|---|---|
| | | | Weight of | Weight of | diluted (30% |
| Ex. | Solv. | Chemical name | concrete | absolute | ethanol) |
| 10 | 1) | Octane (No CAS | 0.33 g | 0.19 g | 0.19 g (absolute) |
| | | 111-65-9) | | | |

### Olfactory Evaluation:

It appears that the Absolute obtained with the process according to the invention (ex. 10) is intensive and powerful, with a camphor, borneol facet. It is distinctive, singular and identical on the olfactory level to the fragrance of the starting raw material, lavandin.

### Examples 11 to 13

The Tonka bean, or coumarou, is a seed produced by several species of tropical trees of the Fabaceae family of the Dipteryx and Taralea genera: mainly Dipteryx odorata, but also, in particular, Dipteryx alata and Taralea oppositifolia.

### Experimental Protocol 1

20 g of Tonka beans are ground beforehand with a grinder of the IKA A 11 type grinder (size of a few millimeters), placed in a 500 ml flask. The extraction solvent (180 g) is then added to the biomass. The flask is then placed on a system of the Rotavapor type, the flask immersing in the bath thermostated at 20° C. (Room Temperature). The latter flask is then stirred (200 revolutions/min) for 2 hours. The mixture can be then filtered on a pleated filter and then the solvent can be evaporated under high vacuum until a colored residue corresponding to the concrete is obtained. The latter can be then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to yield the absolute.

### Experimental Protocol 2

20 g of Tonka beans are pre-ground with a grinder of the IKA A 11 type grinder (size of a few millimeters), placed in a 500 ml flask. The extraction solvent (180 g) is then added to the biomass. The flask is then placed on a Rotavapor type system, the flask immersing in the bath thermostated at 40° C. Said flask is then stirred (200 revolutions/min) for 2 hours. The mixture can be then filtered on a pleated filter then the solvent is evaporated under high vacuum until a colored residue corresponding to the concrete is obtained. The latter can be then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to produce the absolute.

The following test with Tonka beans was carried out:

TABLE 4

| | | | | | | | Amount raw |
|---|---|---|---|---|---|---|---|
| | | | | Weight | | Weight | mat. diluted |
| | | Chemical | | of | | of | (30% |
| Ex. | Solv. | name | Prot. | concrete | | absolute | ethanol) |
| 11 | 9) | Isododécane - | 1 | 10.43 | g | 3.59 g | 1 g |
| | | No CAS | | | | | (absolute) |
| | | 31807-55-3 | | | | | |
| 12 | 9) | Isododécane - | 2 | 5.45 | g | 2.76 g | 0.8 g |
| | | No CAS | | | | | (absolute) |
| | | 31807-55-3 | | | | | |
| 13 | 3) | n-Décane - | 2 | 4.7 | g | 1.61 g | 0.55 g |
| | | No CAS | | | | | (absolute) |
| | | 124-18-5 | | | | | |

### Olfactory Evaluation:

The Tonka bean absolutes obtained with the solvents of the invention (ex. 12 to 14) are very intensive and powerful, coumarinated, powdery, almondy with a note of vanilla. It is identical on the olfactory level to the perfume of the starting raw material.

### Example 14 and Comparative Example 15

Orange blossom, also called “Essence of Neroli”, named after the town of Nerola, comes from the bitter orange tree (Citrus sinensi, Citrus aurantium). This rustic tree belonging to the Rutaceae family can live up to 600 years. This small white flower is particularly appreciated for its powerful, sweet and delicate fragrance.

### Experimental Protocol

20 g of orange blossoms are placed in a 500 ml flask. The extraction solvent (180 g) is then added to the biomass. The flask is then placed on a Rotavapor type system, the flask immersing in the bath thermostated at 40° C. Said flask is then stirred (200 revolutions/min) for 2 hours. The mixture can be then filtered on a pleated filter then the solvent can be evaporated under high vacuum until a colored residue corresponding to the concrete is obtained. The latter can be then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to yield the absolute.

The following test with orange blossoms was carried out:

TABLE 5

| | | | Weight | Weight | Amount raw mat. |
|---|---|---|---|---|---|
| | | | of | of | diluted (30% |
| Ex. | Solv. | Chemical name | concrete | absolute | ethanol) |
| 14 | 1) | Octane (No | 0.04 g | 0.01 g | 0.01 g (absolute) |
| | | CAS 111-65-9) | | | |
| 15 | Comp. 3 | n-Heptane | 0.07 g | 0.01 g | 0.01 g (absolute) |

### Olfactory Evaluation:

The orange blossom absolute obtained according to the invention (ex. 14) is soft, round, petal-like, floral, olfactorily close to the starting biomass. On the other hand, comparative example 15 it presents this unpleasant side of the daisy and olfactorily moves away from the starting biomass.

### Example 16 and Comparative Example 17

Acacia dealbata is a species of tree, commonly referred to as “mimosa flower”, “winter mimosa” or “florist's mimosa”, belonging to the Mimosoideae subfamily.

### Experimental Protocol

20 g of mimosa flowers are placed in a 500 ml flask. The extraction solvent (180 g) is then added to the biomass. The flask is then placed on a Rotavapor type system, the flask immersing in the bath thermostated at 40° C. Said flask is then stirred (200 revolutions/min) for 2 hours. The mixture can be then filtered on a pleated filter then the solvent is evaporated under high vacuum until a slightly yellow residue corresponding to the concrete is obtained. The latter can be then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to yield the absolute.

The following test with mimosa flowers was carried out:

TABLE 6

| | | | Weight | Weight | Amount raw mat. |
|---|---|---|---|---|---|
| | | | of | of | diluted (30% |
| Ex. | Solv. | Chemical name | concrete | absolute | ethanol) |
| 16 | 2) | nonane (No | 0.58 g | 0.27 g | 0.27 g (absolute) |
| | | CAS 111-84-2) | | | |
| 17 | Comp. 4 | n-Heptane | 0.33 g | 0.12 g | 0.12 g (absolute) |

It appears that the concrete and absolute obtained with the process according to the invention have an equivalent or even higher yield than those obtained with the solvents outside the invention (ex. 16 and 17 (Comp.4)).

### Olfactory Evaluation:

The mimosa flower absolute obtained with the solvent of the invention is more floral, greener, more solar.

Comparative example (ex. 17) is sweeter, more jammy. On the olfactory level, example according to the invention (ex. 16) is closer olfactorily to the extracted biomass than the comparative example (ex. 17).

### Example 18

Rosemary is a Mediterranean shrub with an erect and compact habit, with very aromatic evergreen foliage, of the Lamiaceae family of the genus Salvia, mainly Salvia 40 rosmarinus formerly Romarinus officinalis.

### Experimental Protocol

20 g of Salvia rosmarinus spruce needles and twigs are ground beforehand with an IKA A 11 type grinder (size of a few millimeters), placed in a 500 ml flask. The extraction solvent (180 g) is then added to the biomass. The flask is then placed on a Rotavapor type system, the flask immersing in the bath thermostated at 40° C. Said flask is then stirred (200 revolutions/min) for 2 hours. The mixture is then filtered on a pleated filter then the solvent is evaporated under high vacuum until a colored residue corresponding to the concrete is obtained. The latter is then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to yield the absolute.

The following test with rosemary spruce needles and twigs was carried out:

| | | | | | Amount raw mat. |
|---|---|---|---|---|---|
| | | | Weight of | Weight of | diluted (30% |
| Ex | Solv. | Chemical name | concrete | absolute | ethanol) |
| 18 | 2) | nonane (No CAS | 0.58 g | 0.32 g | 0.32 g (absolute) |
| | | 111-84-2) | | | |

### Olfactory Evaluation:

The absolute of rosemary spruce needles and twigs obtained according to the invention (ex. 18) has an olfactory pleasant note, low in terpene, low in camphor, very close to the cut extracted biomass.

### Example 19

### Preparation of the Solid Natural Material:

The rose Rosa centifolia is part of the Rosaceae family (Rosaceae). As its name suggests, it is a rose with a hundred leaves. Its flowers are rather round and offer a nice volume thanks to the many fine overlapping petals. The Centifolia rose comes in the form of homogeneous and flexible bushes which can reach 1.5 meters to 2 meters in height.

The roses after picking (50 g), ready to use, are placed in a 500 ml flask. The extraction solvent (450 g) is then added to the biomass. The flask is then placed on a Rotavapor type system, the flask immersing in the bath thermostated at 40° C. Said flask is then stirred (200 revolutions/min) for 2 hours. The mixture is then filtered on a pleated filter then the solvent is evaporated under high vacuum until a slightly yellow residue corresponding to the concrete is obtained. The latter is then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to produce the absolute.

The following test with the flowers of Rosa centifolia was carried out:

TABLE 8

| | | | | | Amount raw mat. |
|---|---|---|---|---|---|
| | | | Weight of | Weight of | diluted (30% |
| Ex. | Solv. | Chemical name | concrete | absolute | ethanol) |
| 19 | 1) | Octane (No CAS | 0.31 g | 0.2 g | 0.2 g (absolute) |
| | | 111-65-9) | | | |

### Olfactory Evaluation:

The rose absolute obtained with octane provides a floral note, pleasant, powerful and relatively close to biomass.

### Example 20 to 23

This example was carried out according to the method described in the american patent application US 2018/305638 using Cetiol UT (mixture of undecane and tridecane) supplied by BASF. In order to be able to compare the absolutes obtained according to the invention with the perfumed liquid extracts from US 2018/305638, the natural materials (biomass)/solvent weight ratio (1/9) is identical to the preceding examples.

The ready-to-use natural materials (biomass) (20 g) (ground or not) is placed in a 500 ml flask. The extraction solvent (180 g) is then added to the biomass. The flask is then placed on a Rotavapor type system, the flask immersing in the bath thermostated at 40° C. Said flask is then stirred (200 rpm) for 2 hours. The mixture is then filtered through a pleated filter. Perfumed liquid extracts are ready to use

The following tests were carried out:

TABLE 8

| | | | | | Weight |
|---|---|---|---|---|---|
| | | | Ex. according | | obtained |
| | | Comparative | to the | Biomass | after |
| Ex. | Solv. | composition | invention | used | filtration |
| 20 | CETIOL | Comp 5 | Ex. 2 | Vanilla | 181 g |
| | UT | | | pods | |
| 21 | | Comp 6 | Ex. 14 | Orange | 178 g |
| | | | | blossom | |
| 22 | | Comp 7 | Ex. 12 | Tonka | 182 g |
| | | | | beans | |
| 23 | | Comp 8 | Ex. 10 | Lavandin | 177 g |
| | | | | flowers | |

### Olfactory Evaluation:

| | | Comparative results with perfumed CETIOL UT extract |
|---|---|---|
| Ex | Solv. | vs. ex. according to the invention |
| 20 | CETIOL | Significantly lower than the inventive absolute Ex. 2, |
| | UT | Notes missing. Low power and low intensity |
| 21 | | Significantly lower than the inventive absolute Ex. 14. |
| | | Little powerful. Green smell far from biomass. |
| 22 | | Significantly lower than the inventive absolute Ex. 12. |
| | | Much less intense, powerful and persistent |
| 23 | | Significantly lower than the inventive absolute Ex. 10 |
| | | Smoother, less powerful. Little persistence |

In addition to the better yields of the absolutes obtained with the process and the solvents of the invention, it also appears that the odors are significantly better for the absolutes obtained according to the invention than those obtained with the prior art. The absolutes have scents and odors closer to the starting biomass.

1. A process for preparing a perfume concrete and/or a perfume absolute employing at least one step of bringing:
a) a first system of solvents comprising at least one linear or branched alkane solvent comprising at least 8 carbon atoms having a boiling point at atmospheric pressure between 105° C. and 190° C.;
into contact with:
b) one or more fresh, withered or dry solid natural materials chosen from:
i) rose (Rosa platyrhodon, Rosa hesperrhodos, Rosa hulthemia and Rosa eurosa) jasmine (Jasminum) flowers, lavender flowers, lavandin (Lavandula stoechas, Lavandula hybrida, Lavandula angustifolia, formerly officinalis, and Lavandula latifolia) flowers, orange (Citrus sinensis) or bitter orange (Citrus aurantium L) blossom, tuberose (Agave polianthes or Polianthes tuberosa) flowers, ylang-ylang (Cananga odorata) flowers, violet (Viola odorata var. Victoria) flowers, and mimosa (Acacia dealbata, Acacia decurrens) flowers;
ii) geranium (Pelargonium) stems and leaves, patchouli (Pogostemon cablin and Pogostemon heyneamus) stems and leaves and petitgrain (Citrus aurantium) stems and leaves;
iii) fruits chosen from anise (Pimpinella anisum), coriander (Coriandrum sativum), caraway (Carum carvi), cumin (Cumimum cyminum) and juniper (Juniperus);
iv) citrus fruits;
v) mace (Myristica fragrans) seeds, angelica (Angelica archangelica) seeds, celery (Apium graveolens) seeds and cardamom (Elettaria cardamomum) seeds, tonka (Dipteryx odorata) seeds or beans, vanilla (Vanilla planifolia) pods and/or seeds;
vi) angelica (Angelica archangelica) roots, vetiver (Vetiveria) roots and iris roots; vii) sandal woods (Santalum), rosewoods (Aniba rosaeodora), cedarwoods (Cedrus) and lignum vitae (Bulnesia sarmientoi, Guaiacum officinale and Guaiacum sanctum);
viii) herbs and grasses chosen from tarragon (Artemisia dracunculus), lemongrass (Cymbopogon), sage (Salvia), mint (Mentha) and thyme (Thymus);
ix) spruce needles and twigs, fir (Abies) needles and twigs, rosemary (Salvia rosmarimis, formerly Rosmarinus officinalis) needles and twigs, and pine (Pimuis) needles and twigs; and
x) resins and balms derived from galbanum (Ferula galbaniflua or Ferula gummosa), elemi (Canarium), benzoin (Styrax), myrrh (Commiphora myrrha or Commiphora molmol and Commiphora opobalsamum) and olibanum (Boswellia);
it being understood that the seeds or beans v) can be with or without shells, preferably without shells.

2. The process according to claim 1, in which the first solvent system a) comprises at least one alkane solvent comprising at most 15 carbon atoms.

3. The process according to claim 1, in which the first solvent system a) comprises at least one alkane solvent having a boiling point at atmospheric pressure between 110° C. and 180° C.

4. The process according to claim 1, in which the first solvent system a) comprises at least one alkane chosen from those of formula (I) and also the optical isomers thereof: 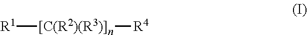
in which formula (I):
R¹ and R⁴, which are identical or different, represent a hydrogen atom or a (C₁-C₄) group;
R² and R³, which are identical or different, represent a hydrogen atom or a (C₁-C₄) alkyl group; and
n represents an integer between 1 and 15,
it being understood that in total the solvent comprises between 8 carbon atoms and 15 carbon atoms.

5. The process according to claim 1, in which the first solvent system a) comprises: at least one alkane solvent chosen from:
1) octane (CAS No. 111-65-9), 2) nonane (CAS No. 111-84-2), 3) decane (CAS No. 124-18-5), 5) dodecane (CAS No. 112-40-3), 7) tetradecane (CAS No. 629-59-4), 8) pentadecane (CAS No. 629-62-9), 9) isododecane (CAS No. 31807-55-3), 10) isohexadecane (CAS No. 43-04-9), 11) n-hexadecane, 12) n-octadecane, 13) n-nonadecane, 14) hemisqualane, 15) isodecane, 16) C₈-C₉ isoparaffin, and 17) C₁₁-C₁₃ isoparaffin.

6. The according to claim 1, in which the system of solvent(s) comprises at least 50% by volume of alkane solvent(s) relative to the total volume of the first solvent system.

7. The according to claim 1, in which the natural material(s) i) to x) has (have) been ground, said grinding operation(s) having been carried out before bringing into contact with the first solvent system a).

8. The according to claim 1, in which the natural material(s) is (are) chosen from i), v) and viii).

9. The according to claim 1, in which the contacting operation is carried out at ambient temperature, with or without stirring.

10. The according to claim 1, in which the contacting operation is a solid/liquid extraction step.

11. The according to claim 1, in which the optionally sonicated a)+b) mixture is heated at a temperature above 20° C.

12. The according to claim 1, in which the reactor in which the a)+b) mixture is found comprises a cooling system or condenser for cooling and condensing the solvent(s) of the system of solvent(s) a); in order to obtain, after separation, extraction and evaporation of the solvent(s), a perfume concrete.

13. A process for preparing a perfume concrete according to claim 1 implementing:
1) at least one step of bringing:
a) a first system of solvent(s) into contact with
b) one or more solid natural material(s) chosen from i) to x); then
2) the a)+b) mixture is optionally subjected to a sonication step;
3) the system of solvents is maintained at a temperature at least 1° C. to 5° C. below or equal to the boiling point of the solvent having the lowest boiling point; the contacting and solid/liquid extraction step is followed by a step of recovery of the natural extract resulting from the natural material(s); this recovery can be carried out by filtration, distillation, or with a Soxhlet;
4) the solvent(s) of the extract is (are) removed to result in the concrete; or else the natural material(s) which has (have) not been dissolved is (are) separated from its (their) supernatant(s); the supernatant(s) can subsequently be separated and recovered and the solvent(s) of said supernatant(s) is (are) removed by evaporation of solvents to result in the concrete.

14. The process according to claim 12, in which the concrete is brought into contact with at least one second system of polar solvent(s), then the pellet is separated from the supernatant, in order to obtain, after separation, and evaporation of the solvent(s), a perfume absolute.

15. A concrete obtained by the preparation process according to claim 1.

16. A perfume absolute obtained by the preparation process according to claim 14.

17. A composition comprising:
one or more concrete(s) and/or one or more perfume absolute(s) obtained by the preparation process according to claim 1.

18. A method for treating keratin materials employing the application of one or more concrete(s) and/or one or more perfume absolute(s) obtained by the preparation process according to claim 1, by application of the one or more concrete(s) and/or one or more perfume absolute(s), it being understood that the one or more concrete(s) and/or one or more perfume absolute(s) can be contained in a composition.

19. A method for perfuming:
keratin materials
textile materials
wood,
paper, and/or
articles made of leather
employing one or more concrete(s) and/or one or more perfume absolute(s) obtained by the preparation process according to claim 1, by applying or spraying the) the one or more concrete(s) and/or one or more perfume absolute(s) over the textile(s) or into the ambient air, it being understood that the concrete and/or the absolute can be contained in a composition.

20. (canceled)

21. A method for the perfuming:
of keratin materials,
of textile materials,
of wood,
of paper,
of articles made of leather and/or
the atmosphere which method comprises using one or more concrete(s) and/or one or more perfume absolute(s) obtained by the preparation process according to claim 1.

22. A method for extracting one or more concrete(s) and/or one or more perfume absolute(s) obtained by the preparation process according to claim 1 with no petroleum ether odour one or more fresh, withered or dry solid natural materials chosen from:
i) rose (Rosa platyrhodon, Rosa hesperrhodos, Rosa hulthemia and Rosa eurosa) jasmine (Jasmimum) flowers, lavender flowers, lavandin (Lavandula stoechas, Lavandula hybrida, Lavandula angustifolia, formerly officinalis, and Lavandula latifolia) flowers, orange (Citrus sinensis) or bitter orange (Citrus aurantium L) blossom, tuberose (Agave polianthes or Polianthes tuberosa) flowers, ylang-ylang (Cananga odorata) flowers, violet (Viola odorata var. Victoria) flowers, and mimosa (Acacia dealbata, Acacia decurrens) flowers;
ii) geranium (Pelargonium) stems and leaves, patchouli (Pogostemon cablin and Pogostemon heyneamis) stems and leaves and petitgrain (Citrus aurantium) stems and leaves;
iii) fruits chosen from anise (Pimpinella anisum), coriander (Coriandrum sativum), caraway (Carum carvi), cumin (Cumimum cymimim) and juniper (Juniperus);
iv) citrus fruits;
v) mace (Myristica fragrans) seeds, angelica (Angelica archangelica) seeds, celery (Apium graveolens) seeds and cardamom (Elettaria cardamomum) seeds, tonka (Dipteryx odorata) seeds or beans, vanilla (Vanilla planifolia) pods and/or seeds;
vi) angelica (Angelica archangelica) roots, vetiver (Vetiveria) roots and iris roots; vii) sandal woods (Santalum), rosewoods (Aniba rosaeodora), cedarwoods (Cedrus) and lignum vitae (Bulnesia sarmientoi, Guaiacum officinale and Guaiacum sanctum);
viii) herbs and grasses chosen from tarragon (Artemisia dracunculus), lemongrass (Cymbopogon), sage (Salvia), mint (Mentha) and thyme (Thymus);
ix) spruce needles and twigs, fir (Abies) needles and twigs, rosemary (Salvia rosmarinus, formerly Rosmarimis officinalis) needles and twigs, and pine (Pinus) needles and twigs; and
x) resins and balms derived from galbanum (Ferula galbaniflua or Ferula gummosa), elemi (Canarium), benzoin (Styrax), myrrh (Commiphora myrrha or Commiphora molmol and Commiphora opobalsamum) and olibanum (Boswellia);
it being understood that the seeds or beans v) can be with or without shells, comprising using a system of solvent(s) a) comprising at least one alkane solvent comprising at least 8 carbon atoms.
